(19) United States
(12) Patent Application Publication
(10) Pub. No.: US 2025/0021368 A1
(43) Pub. Date: Jan. 16, 2025

(54) SIMULATED EVENT ORCHESTRATION FOR A DISTRIBUTED CONTAINER-BASED SYSTEM

(71) Applicant: VMWARE, INC., Palo Alto, CA (US)

(72) Inventors: GURIVI REDDY GOPIREDDY, Bangalore (IN); AAKASH CHANDRASEKARAN, Bangalore (IN); PRIYANKA BHASKAR, Bangalore (IN); HEMANT SADANA, Bangalore (IN); VENU GOPALA RAO KOTHA, Bangalore (IN); UMAR SHAIKH, Dubai (AE)

(21) Appl. No.: 18/376,008

(22) Filed: Oct. 3, 2023

(30) Foreign Application Priority Data
Jul. 14, 2023 (IN) 202341047539

(51) Int. Cl. G06F 9/455

(52) U.S. Cl. CPC G06F 9/45558; G06F 2009/45595

(57) ABSTRACT

The disclosure provides a method for orchestrating simulated events in a distributed container-based system. The method generally includes monitoring, by a chaos controller deployed in a management cluster of the container-based system, for new objects generated at the management cluster, wherein the management cluster is configured to manage a plurality of simulated workload clusters in a simulation system, based on the monitoring, discovering, by the chaos controller, a new object generated at the management cluster providing information about events intended to be simulated for one or more simulated workload clusters of the plurality of simulated workload clusters, determining a plan for orchestrating a simulation of the events in the one or more simulated workload clusters based on the information provided in the new object, and triggering the simulation of the events in accordance with the plan.

### RELATED APPLICATIONS

Benefit is claimed under 35 U.S.C. 119(a)-(d) to Foreign application No. 202341047539 filed in India entitled “SIMULATED EVENT ORCHESTRATION FOR A DISTRIBUTED CONTAINER-BASED SYSTEM”, on Jul. 14, 2023, by VMware, Inc., which is herein incorporated in its entirety by reference for all purposes.

Modern applications are applications designed to take advantage of the benefits of modern computing platforms and infrastructure. For example, modern applications can be deployed in a multi-cloud or hybrid cloud fashion. A multi-cloud application may be deployed across multiple clouds, which may be multiple public clouds provided by different cloud providers or the same cloud provider or a mix of public and private clouds. The term, “private cloud” refers to one or more on-premises data centers that might have pooled resources allocated in a cloud-like manner. Hybrid cloud refers specifically to a combination of public and private clouds. Thus, an application deployed across a hybrid cloud environment consumes both cloud services executing in a public cloud and local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that depend on a shared operating system (OS) kernel. Containerized applications (also referred to as workloads), can include a collection of one or more related applications packaged into one or more containers. In some orchestration systems, a set of one or more related containers sharing storage and network resources, referred to as a pod, may be deployed as a unit of computing software. Container orchestration systems automate the lifecycle of containers, including such operations as provisioning, deployment, monitoring, scaling (up and/or down), networking, and load balancing.

Kubernetes® (K8S®) software is an example open-source container orchestration system that automates the deployment and operation of such containerized applications. In particular, Kubernetes may be used to create a cluster of interconnected nodes, including (1) one or more worker nodes that run the containerized applications (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine, or a VM configured to run on a physical machine running a hypervisor.

In some cases, the container orchestration system, running containerized applications, is distributed across a cellular network. A cellular network provides wireless connectivity to moving devices and generally comprises two primary subsystems: a mobile core connected to the Internet and a radio access network (RAN) composed of cell sites. In a RAN deployment, such as a fifth-generation network technology (5G) RAN deployment, cell site network functions may be realized as pods in container-based infrastructure. In particular, each cell site is deployed with an antenna and one or more hosts. The cell site hosts may be used to execute various network functions using containers (referred to herein as “cloud-native network functions (CNFs)). The CNFs may be deployed as pods of containers running within VMs of the cell site hosts or directly on an operating system (OS) of the cell site hosts.

5G is expected to deliver a latency of under five milliseconds and provide transmission speeds up to about 20 gigabytes per second. To meet the 5G requirements, with respect to high network throughput and low latency, cell site hosts and VMs are configured to include specialized hardware, software, and customizations. For example, hosts at a 5G cell site may include 5G specific accelerator network cards, precision time protocol (PTP) devices, basic input/output system (BIOS) tuning, firmware updates, and/or driver installation to support 5G network adapters. In some cases, a telecommunication cloud platform (TCP) enables configuring cell site hosts and VMs of the 5G cellular network as such. In particular, the TCP uses a centralized management server to manage and customize numerous cell site hosts and VMs (e.g., a 5G RAN deployment may include more than 10,000 remote cell sites managed by the TCP) of the cellular network to support 5G RAN telecommunication requirements.

To verify functionalities and performance of customized cell site hosts and VMs in the large scale RAN deployment, the TCP may include a simulation system. The simulation system provides a test infrastructure for end-to-end scale verification of node creation and customization of mock hosts and mock VMs of RAN cell sites, as well as a mock centralized management server configured to manage such mock hosts and VMs.

The test infrastructure, provided by the TCP simulation system, may be further used to simulate the deployment and execution of various containerized applications (e.g., software processes, such as CNFs) on the mock cell site nodes. As such, information about application functionality, reliability, and responsiveness may be collected and evaluated to understand overall application performance in the RAN deployment. Such application performance monitoring may be designed to help ensure that these applications meet the performance requirements expected by users to help ensure a valuable user experience is provided.

In some cases, an ability of the simulation system to create chaos in the simulated (e.g., non-production) RAN environment may be desired to test the resilience of cell site nodes, as well as the effect such induced chaos has on application performance. In particular, chaos engineering is the process of stressing an application in testing and/or production environments by creating disruptive events observing how the system responds, and implementing improvements. Example disruptive events may include outages, failures/faults, excess churn (e.g., shorter cycles through which Kubernetes resources, such as clusters, nodes, pods, and/or containers, are created, destroyed, and later recreated), and/or other changes in Kubernetes resources that disrupt the system. Chaos engineering helps to create real-world conditions needed to uncover hidden issues and performance bottlenecks that may be difficult to identify, especially in distributed systems, such as a cellular network (e.g., having a mobile core and a RAN composed of multiple remote cell sites).

### SUMMARY

One or more embodiments provide a method for orchestrating simulated events in a distributed container-based system. The method generally includes monitoring, by a chaos controller deployed in a management cluster of the container-based system, for new objects generated at the management cluster. The management cluster may be configured to manage a plurality of simulated workload clusters in a simulation system. Based on the monitoring, the method generally includes discovering, by the chaos controller, a new object generated at the management cluster providing information about events intended to be simulated for one or more simulated workload clusters of the plurality of simulated workload clusters. The method generally includes determining a plan for orchestrating a simulation of the events in the one or more simulated workload clusters based on the information provided in the new object. Further, the method generally includes triggering the simulation of the events in accordance with the plan.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 illustrates an example cellular network, having at least a software-defined data center (SDDC) including a simulation system, a mobile core, and multiple cell sites, in which embodiments of the present disclosure may be implemented.

FIGS. 2A and 2B illustrate an example container execution environment run on cell site hosts, according to an example embodiment of the present disclosure.

FIG. 3 illustrates example components of the SDDC, including the simulation system, illustrated in the cellular network of FIG. 1, according to an example embodiment of the present disclosure.

FIG. 4A illustrates example operations for introducing event(s) in one or more simulated container-based clusters, according to an example embodiment of the present disclosure.

FIG. 4B illustrates an example system used to simulate event(s) in one or more simulated container-based clusters, according to an example embodiment of the present disclosure.

FIGS. 5-8 illustrate example chaos resource custom resource specifications, according to example embodiments of the present disclosure.

FIG. 9 illustrate example key-value pairs in a ConfigMap, according to example embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for orchestrating simulated, disruptive events (simply referred to herein as “events”) in a distributed container-based system are described herein. The distributed container-based system may be a container orchestration system, such as Kubernetes, distributed across a cellular network having a mobile core and a RAN composed of multiple remote cell sites. Though certain embodiments are described with respect to Kubernetes, the techniques and embodiments herein are also applicable to other container orchestration platforms.

The event simulation described herein may be used to perform event injection experiments for one or more entities of the distributed container-based system, such as clusters, hosts, and/or virtual machines (VMs), in a simulated environment. The event injection experiments may be controlled experiments in order to evaluate how well the distributed container-based system, and/or particular applications deployed in the container-based system, continue to perform when various events are injected. As described above, example events may include outages, failures/faults, excess churn, and/or other changes in Kubernetes resources that disrupt the system. Controlled event injection experiments, enabled via the techniques described herein, may allow for precise control of extraneous and independent variables to allow for easier identification of bottlenecks and/or issues in the system.

To support event orchestration in the simulated, distributed container-based system, a chaos controller is introduced. The chaos controller is configured to orchestrate the injection of various types of events in the system to observe how the system responds to different stressors. For example, the chaos controller may control the type of events introduced in the system, a timing for introducing these events, and/or the specific Kubernetes resources exposed to the simulated events. The goal of such fault injection is to observe how different stressors and/or abnormalities affect operations of the system, its resources (e.g., clusters, hosts, VMs, etc.), and application performance, identify limits and point(s) of failure within the system, and provide insight with respect to system improvement to make the system more resilient.

In certain embodiments, the chaos controller determines the types of events for injection based on chaos resource objects created in the Kubernetes platform. In particular, a Kubernetes platform is made up of a central database containing Kubernetes objects, or persistent entities, that are managed in the platform. Kubernetes objects are represented in configuration files and describe the intended state of a Kubernetes cluster. Kubernetes objects may include native Kubernetes objects and custom resource (CR) objects, also referred to herein as “custom resources.” A custom resource is an object that extends the API of the control plane of a container orchestration platform or allows a user to introduce their own API into the cluster. For example, a user may generate a custom resource definition (CRD), such as in a YAML file, the CRD defining the building blocks (e.g., structure) of the custom resource. Instances of the custom resource as defined in the CRD can then be deployed in the cluster, such as by using a custom resource specification (e.g., another YAML file) that describes an intended state of the custom resource. A chaos resource object is an example custom resource that may be introduced in Kubernetes. The chaos resource object may declare the number, type and/or frequency of events that are to be simulated in the system. Further, the chaos resource object may declare one or more targets of the simulated event(s). The chaos resource object is a “record of intent;” thus, once a chaos resource object is created, the chaos controller will constantly work to ensure that the intended state represented by the object, i.e., the desired event(s), are realized in the system. In other words, the chaos controller works to orchestrate the injection of one or more events in the system according to specifics provided in the chaos resource object.

The chaos resource object is deployed as a pod in a management cluster of the distributed container-based system. In particular, the distributed container-based system may include a management cluster and one or more workload clusters. In certain aspects, the management cluster is a Kubernetes cluster that runs cluster API operations to create and manage workload clusters. Workload clusters are the Kubernetes clusters having one or more worker nodes that run containerized applications. Deploying the chaos controller in the management cluster allows for centralized event simulation and injection. In particular, event injection is not limited to a particular workload cluster. Instead, the chaos controller has the ability to inject events across multiple workload clusters and their components to provide a better understanding of overall system performance when affected by different stressors and/or abnormalities. As such, a more comprehensive understanding of issues and/or performance bottlenecks in the system may be achieved.

The system described herein provides significant technical advantages, such as an ability to efficiently, and in a cost-effective manner, orchestrate simulated events for a distributed container-based system. In particular, simulation is less expensive than real-world experimentation. The potential costs of creating a real-world test environment for understanding application performance at scale, including understanding the behavior of applications when there is a disruption, a fault, a hardware misbehavior, an underlying system issue, and/or when a large number of events are generated, may be large due to the amount of resources/hardware required. Fault simulation reduces these costs by enabling application performance assessment and verification, when stressors are introduced in the system, with minimal hardware. Further, assessing the impact different simulated events have on the system, allows for improvements to be made to the system to lessen the impact of similar events happening in real-world Kubernetes deployments.

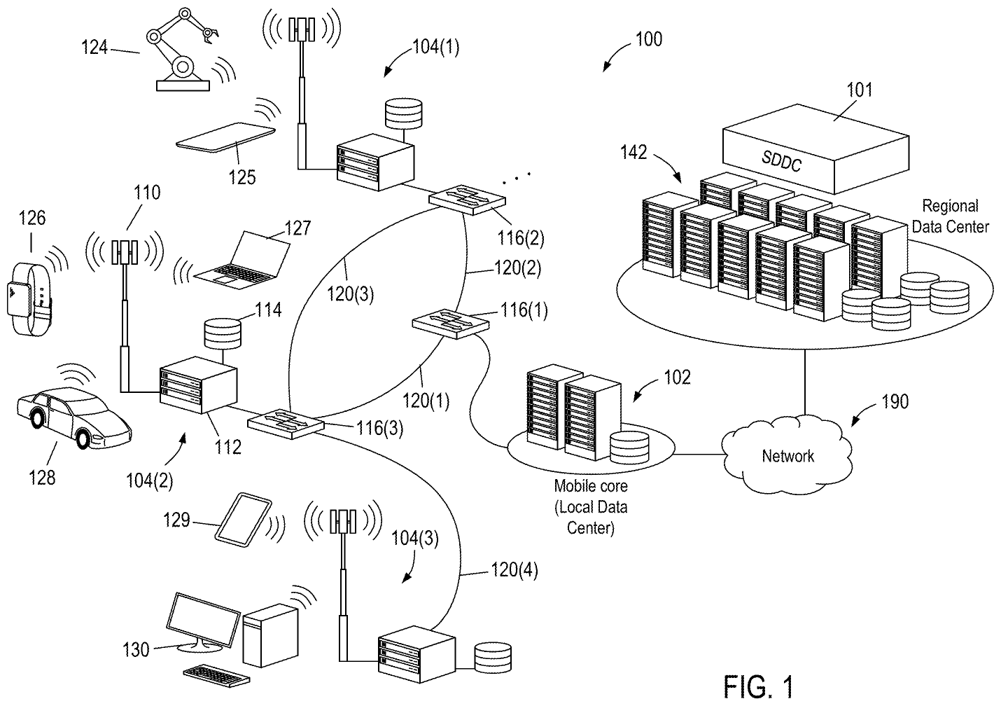

FIG. 1 illustrates an example cellular network 100 in which embodiments of the present disclosure may be implemented. Cellular network 100 provides wireless 5G connectivity to user equipment(s) (UE(s)). UEs include mobile phones, computers, automobiles, drones, industrial and agricultural machines, robots, home appliances, and Internet-of-Things (IoT) devices. Example UEs illustrated in FIG. 1 include a robot 124, a tablet 125, a watch 126, a laptop 127, an automobile 128, a mobile phone 129, and a computer 130. To provide such 5G connectivity, cellular network 100 includes a mobile core 102, a RAN composed of cell sites, such as example cell sites 104(1)-104(3) (individually referred to herein as “cell site 104” and collectively referred to herein as “cell sites 104”), and a telecommunication cloud platform (TCP) deployed in a software-defined data center (SDDC) 101 at a regional data center (RDC) 142.

Mobile core 102 is the center of cellular network 100. Cellular network 100 includes a backhaul network that comprises intermediate links, such as cables, optical fibers, and switches, and connects mobile core 102 to cell sites 104. In the example of FIG. 1, the backhaul network includes switches 116(1)-116(3) and intermediate links 120(1)-120(4). In certain embodiments, the intermediate links 120 are optical fibers. In certain embodiments, the backhaul network is implemented with wireless communications between mobile core 102 and cells sites 104.

Mobile core 102 is implemented in a local data center (LDC) that provides a bundle of services. For example, mobile core 102 provides (1) internet connectivity data and voice services, (2) ensures the connectivity satisfies quality-of-service (QoS) requirements of communication service providers (CSPs), (3) tracks UE mobility to ensure uninterrupted service as users travel, and (4) tracks subscriber usage for billing and charging. Mobile core 102 provides a bridge between the RAN in a geographic area and a larger IP-based Internet.

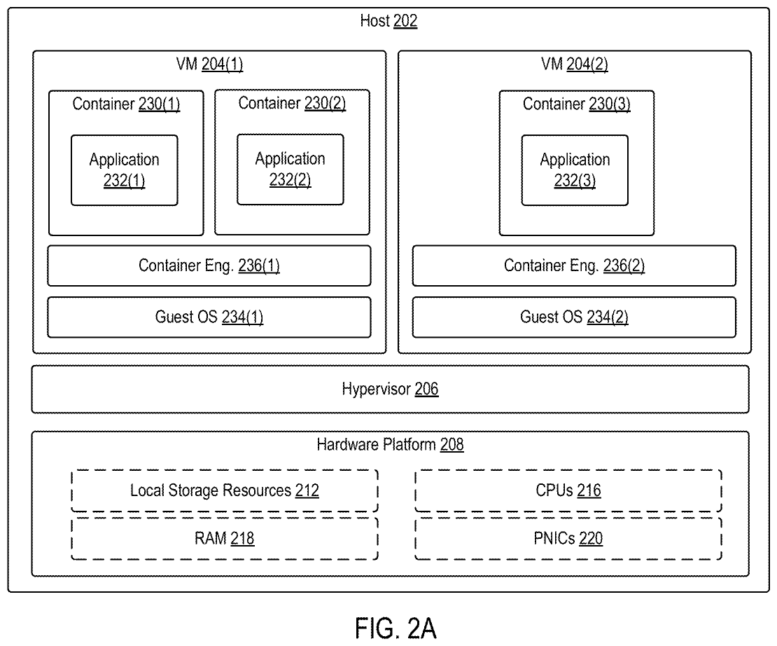

The RAN can span dozens, or even hundreds, of cell sites 104. Each cell site 104 includes an antenna 110 (e.g., located on a tower), one or more computer systems 112, and a data storage appliance 114. Cells sites 104 are located at the edge of cellular network 100. Computer systems 112 at each cell site 104 run management services that maintain the radio spectrum used by the UEs and make sure the cell site 104 is used efficiently and meets QoS requirements of the UEs that communicate with the cell site. Computer systems 112 are examples of host computer systems or simply “hosts.” A host is a geographically co-located server that communicates with other hosts in cellular network 100. Network functionalities performed at cell sites 104 are implemented in distributed applications with application components that are run in virtual machines (VMs) or in containers that run on cell site 104 hosts. Additional details regarding an example container execution environment run on cell site 104 hosts is provided in FIGS. 2A and 2B.

SDDC 101 is in communication with cell sites 104 and mobile core 102 through a network 190. Network 190 may be a layer 3 (L3) physical network. Network 190 may be a public network, a wide area network (WAN) such as the Internet, a direct link, a local area network (LAN), another type of network, or a combination of these.

SDDC 101 runs a telecommunications cloud platform (TCP) (not illustrated in FIG. 1) for managing the virtual environments of cell sites 104, and the LDC used to execute mobile core 102. The TCP uses a centralized management server to manage, customize, and/or monitor components of cell sites 104 (e.g., hosts, VMs, etc.) to help ensure cell site 5G requirements are met, and more specifically, high network throughout and low latency requirements. The centralized management server may be a virtualization management platform deployed to carry out administrative tasks for hosts and/or VMs of the cell sites.

The TCP may include a simulation system. In certain embodiments, the simulation system is designed to simulate, in a test environment, a mock virtualization management platform, mock cell site hosts, mock cell site VMs, etc. to handle application programming interface (API) requests. Further, the simulation system is configured to simulate the deployment and execution of various containerized applications, such as cloud-native network functions (CNFs) deployed as software processes, on the mock cell site components of the test environment, to evaluate application performance. For example, the mock cell site hosts and VMs may be simulated to execute various network functions using containers (e.g., CNFs). The CNFs may be simulated as mock pods of containers running within mock cell site VMs of the mock cell site hosts or directly on an operating system (OS) of the mock cell site hosts.

Further, in certain embodiments, the simulation system is configured to create chaos in the test environment, or in other words, simulate and orchestrate event injection experiments in the test environment to obtain information about application functionality, reliability, and responsiveness to change. Such events may be disruptive and/or introduce stressors in the test environment. Additional details regarding event simulation are provided below.

FIGS. 2A and 2B illustrate an example container execution environment run on cell site 104 hosts, according to an example embodiment of the present disclosure. In particular, FIG. 2A illustrates a cell site host 202 (e.g., an example of a computer system 112 illustrated in FIG. 1) configured to run containerized applications.

Host 202 may be constructed on a server grade hardware platform 208, such as an x86 architecture platform. Hardware platform 208 of each host 202 includes components of a computing device such as one or more processors (central processing units (CPUs)) 216, memory (random access memory (RAM)) 218, one or more network interfaces (e.g., physical network interfaces (PNICs) 220), local storage 212, and other components (not shown). CPU 216 is configured to execute instructions that may be stored in memory 218, and optionally in storage 212. The network interface(s) enable host 202 to communicate with other devices via a physical network, such as management network and/or a data network. In certain embodiments, host 202 is configured to access an external storage (e.g., a storage area network (SAN), a virtual SAN, network attached storage (NAS), or the like) using PNICs 220. In another embodiment, host 202 contains a host bus adapter (HBA) through which input/output operations (I/Os) are sent to an external storage over a separate network (e.g., a fibre channel (FC) network).

Host 202 may be configured to provide a virtualization layer, also referred to as a hypervisor 206, which abstracts processor, memory, storage, and networking resources of hardware platform 208 of host 202 into one or multiple VMs 204 that run concurrently on host 202, such as VM 204(1) and VM 204(2) running on host 202 in FIG. 2A. In certain embodiments, hypervisor 206 runs in conjunction with an OS (not shown) in host 202. In certain embodiments, hypervisor 206 is installed as system level software directly on hardware platform 208 of host 202 (often referred to as “bare metal” installation) and is conceptually interposed between the physical hardware and the guest OSs 234 executing in the VMs 204. It is noted that the term “operating system” or “OS,” as used herein, may refer to a hypervisor. One example of hypervisor 206 that may be configured and used in embodiments described herein is a VMware ESXi™ hypervisor provided as part of the VMware vSphere® solution made commercially available by VMware, Inc. of Palo Alto, CA.

Further, each of VMs 204 implements a virtual hardware platform that supports the installation of a guest OS 234 which is capable of executing one or more applications 232. Guest OS 234 may be a standard, commodity operating system. Examples of a guest OS 234 include Microsoft Windows, Linux, and/or the like. Applications 232 may be any software program, such as a word processing program.

In certain embodiments, each VM 204 includes a container engine 236 installed therein and running as a guest application under control of guest OS 234. Container engine 236 is a process that enables the deployment and management of virtual instances, referred to herein as “containers 230,” in conjunction with OS-level virtualization on guest OS 234 within VM 204. Containers 230 provide isolation for user-space processes executing within them. Containers 230 encapsulate an application 232 as a single executable package of software that bundles application code together with all of the related configuration files, libraries, and dependencies required for it to run. In certain embodiments, containers 230 are used to execute various network functions in cellular network 100, illustrated in FIG. 1.

Kubernetes provides a platform for automating deployment, scaling, and operations of such containers 230 across cell site hosts 202. In particular, Kubernetes implements an orchestration control plane, such as a Kubernetes control plane, to deploy containers 230 running on cell site hosts 202. Kubernetes may be used to create a cluster of interconnected nodes, including (1) worker nodes that run containerized applications and/or services (e.g., in a worker plane) and (2) one or more control plane nodes (e.g., in a control plane) that control the cluster.

An example container-based cluster for running containerized applications and CNFs is illustrated in FIG. 2B. While the example container-based cluster shown in FIG. 2B is a Kubernetes cluster 270, in other examples, the container-based cluster may be another type of container-based cluster based on container technology, such as Docker Swarm clusters. As illustrated in FIG. 2B, Kubernetes cluster 270 comprises worker nodes 272 that run one or more pods 252 having containers 230. Further, Kubernetes cluster 270 comprises control plane node(s) 274 having control plane components running thereon that control the cluster (e.g., where a node is a physical machine, such as a hosts 202, or a VM 204 configured to run on a host 202).

Each worker node 272 includes a kubelet 275. Kubelet 275 is an agent that helps to ensure that one or more pods 252 run on each worker node 272 according to a defined state for the pods 252, such as defined in a configuration file. Each pod 252 may include one or more containers 230. The worker nodes 272 can be used to execute various applications and software processes (e.g., CNFs) using containers 230. Further, each worker node 272 may include a kube proxy (not illustrated in FIG. 2B). A kube proxy is a network proxy used to maintain network rules. These network rules allow for network communication with pods 252 from network sessions inside and/or outside of Kubernetes cluster 270.

Control plane 276 (e.g., running on one or more control plane nodes 274) includes components such as an application programming interface (API) server 262, controller(s) 264, a cluster store (etcd) 266, and scheduler(s) 168. Control plane 276's components make global decisions about Kubernetes cluster 270 (e.g., scheduling), as well as detect and respond to cluster events.

API server 262 operates as a gateway to Kubernetes cluster 270. As such, a command line interface, web user interface, users, and/or services communicate with Kubernetes cluster 270 through API server 262. One example of a Kubernetes API server 262 is kube-apiserver. The kube-apiserver is designed to scale horizontally—that is, this component scales by deploying more instances. Several instances of kube-apiserver may be run, and traffic may be balanced between those instances.

Controller(s) 264 is responsible for running and managing controller processes in Kubernetes cluster 270. As described above, control plane 276 may have (e.g., four) control loops called controller processes, which watch the state of Kubernetes cluster 270 and try to modify the current state of Kubernetes cluster 270 to match an intended state of Kubernetes cluster 270. Scheduler(s) 268 is configured to allocate new pods 252 to worker nodes 272.

Cluster store (etcd) 266 is a data store, such as a consistent and highly-available key value store, used as a backing store for Kubernetes cluster 270 data. In certain embodiments, cluster store (etcd) 266 stores objects(s) 282 represented in configuration files, such as JavaScript Object Notation (JSON) or YAML files, made up of one or more manifests or specifications that declare an intended state (e.g., intended system infrastructure, applications, etc.) for Kubernetes cluster 270.

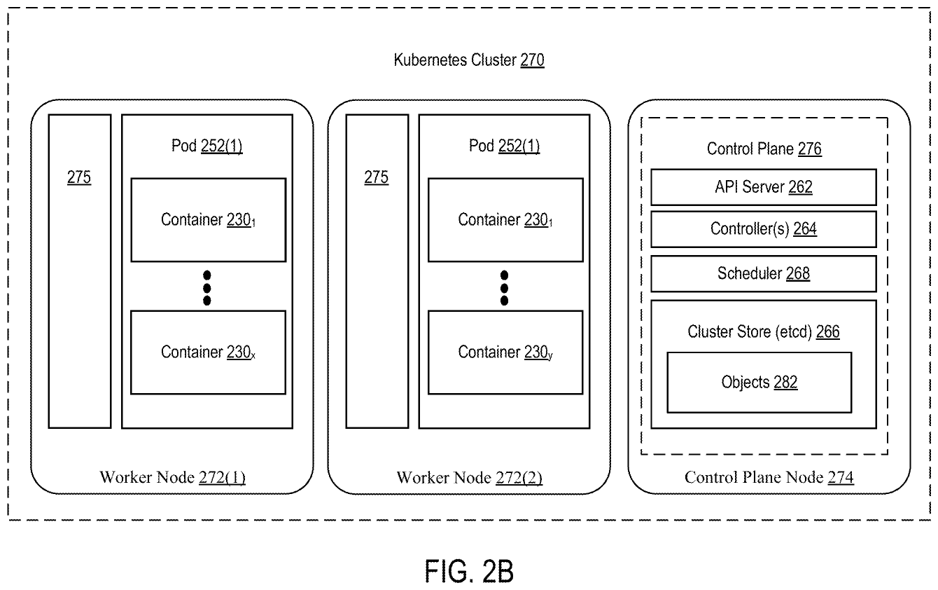

FIG. 3 illustrates example components of the SDDC 101 illustrated in the cellular network of FIG. 1, according to an example embodiment of the present disclosure. As illustrated, SDDC 101 runs on RDC 142 and includes a virtualization management platform 304, a network virtualization platform 306, a workflow automation platform 308, a TCP (e.g., illustrated as TCP control plane 310 and a TCP manager 312), and a Kubernetes management cluster 318 (simply referred to as “management cluster 318”). Further, as described above, SDDC 101 includes a simulation system 334 that provides a test infrastructure for simulated Kubernetes cluster(s), such as simulated Kubernetes RAN workload cluster(s) 336 (simply referred to herein as “workload cluster(s) 336”).

Virtualization management platform 304 manages virtual and physical components, such as VMs, hosts, and dependent components, from a centralized location in SDDC 101. Virtualization management platform 304 is a computer program that executes in a host in SDDC 101, or alternatively, virtualization management platform 304 runs in a VM deployed on a host in SDDC 101. One example of a virtualization management platform 302 is the vCenter Server® product made commercially available by VMware, Inc. of Palo Alto, California.

Network virtualization manager 306 is a physical or virtual server that orchestrates a software-defined network layer. A software-defined network layer includes logical network services executing on virtualized infrastructure (e.g., of hosts). The virtualized infrastructure that supports logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure.

In certain embodiments, network virtualization manager 306 includes one or more virtual servers deployed as VMs in SDDC 101. One example of a software-defined networking platform that can be configured and used in embodiments described herein as network virtualization manager 306 and the software-defined network layer is a VMware NSX® platform made commercially available by VMware, Inc. of Palo Alto, California.

The SDDC 101 runs a workflow automation platform 308 which is an automated management tool that integrates workflows for VMs and containers. An example workflow automation platform 308 may be vRealize Orchestrator (VRO) provided by VMware, Inc. of Palo Alto, California.

TCP control plane 310 connects the virtual infrastructure of cell sites 104 and mobile core 102 (e.g., illustrated in FIG. 1) with RDC 142. TCP control plane 310 supports several types of virtual infrastructure managers (VIMs), such as virtualization management platform 302. The TCP connects with TCP control plane 310 to communicate with the VIMs. TCP Manager 314 is configured to execute an IAE 316 that automatically connects with TCP control plane 310 through site pairing to communicate with VIM(s). Further, TCP manager 314 posts workflows to TCP control plane 310.

SDDC 101 enables management of large-scale cell sites 104 at a central location, such as from a console of a system administrator located at RDC 142. Hosts of cell sites 104 (e.g., such as host 202 in FIG. 2) are added and managed by virtualization management platform 302 through an API of virtualization management platform 302. In some embodiments, a RAN cluster may be deployed having container orchestration platform worker nodes (e.g., Kubernetes worker nodes 272 in FIG. 2B) and container orchestration platform control plane nodes (e.g., Kubernetes control plane nodes 274 in FIG. 2B). The container orchestration platform worker nodes and control plane nodes may be deployed as VMs at different cell sites 104 in a cellular network (e.g., cellular network 100 in FIG. 1).

Management cluster 318, in FIG. 3, may be deployed in SDDC 101 subsequent to deploying the RAN cluster at cell sites 104. Management cluster 318 is a Kubernetes cluster that runs cluster API operations on a specific cloud provider to create and manage workload clusters on that provider. Management cluster 318 may also include worker nodes and control plane nodes, similar to the RAN cluster deployed at cell sites 104. As such, management cluster 318 may include control plane components described with respect to FIG. 2B, such as an API server 320, a cluster store (etcd) 322, one or more schedulers and one or more controllers (e.g., only shown as VM configuration operator 328, node simulation controller 330 and chaos controller 332 (described in detail below), although other schedulers and/or controllers may be running on Management cluster 318).

In certain embodiments, to tune and optimize large-scale cell site 104 VMs to meet 5G RAN cell site 104 requirements, management cluster 318 includes a VM customization operator 328. VM customization operator 328 customizes VMs, cell site 104 VMs in cellular network 100 depicted and described with respect to FIG. 1, based on 5G requirements. In certain embodiments, management cluster 318 includes a node simulation controller 330. Node simulation controller 330 may be configured to control the simulation (e.g., by cell site simulator 342) of nodes (e.g., hosts and VMs) in a test infrastructure, such as mock VMs representing cell site 104 VMs in cellular network 100.

Simulation system 334 is a (e.g., cloud native) simulation system that provides a test infrastructure used to support system performance verification, including the performance of applications in a distributed container-based system (e.g., a Kubernetes platform distributed across a cellular network having a mobile core and a RAN composed of multiple remote cell sites). Simulation system 334 is configured to simulate Kubernetes workload clusters, having one or more mock nodes (e.g., mock hosts and/or mock VMs) executing various containerized applications. The Kubernetes workload clusters may include one or more workload clusters 336. Simulation system 334 may simulate a workload cluster 336 by simulating the creation/configuration/customization and deployment of mock nodes and mock VMs in a test cellular network environment.

Simulation system 334 includes a cell site simulator 342 that simulates mock virtualization management platform(s) managing multiple mock hosts, as well as mock VMs running on those mock hosts. In particular, cell site simulator 342 may be configured to simulate a model with a mock datacenter, mock clusters (e.g., workload clusters 336), mock hosts, mock VMs, mock resource pools, and mock networks. Cell site simulator 342 is deployed in a pod of simulation system 334. Simulation system 334 comprehensively simulates RAN cell site hosts and VMs as mock hosts and VMs using cell site simulator 342. This simulated RAN may be used for the deployment and execution of various containerized applications (e.g., CNFs) on the mock cell site nodes to obtain information about application and/or system functionality, reliability, and/or responsiveness.

Additional details regarding cell site simulation are provided in patent application Ser. No. 17/887,761, filed Aug. 15, 2022, and entitled “Automated Methods and Systems for Simulating a Radio Access Network,” the entire contents of which are incorporated by reference herein.

In addition to managing workload clusters in a production environment, management cluster 318 may also be configured to manage workload clusters 336 created in the test environment by cell site simulator 342. Management cluster 318 may manage one or multiple workload clusters 336 in the test environment.

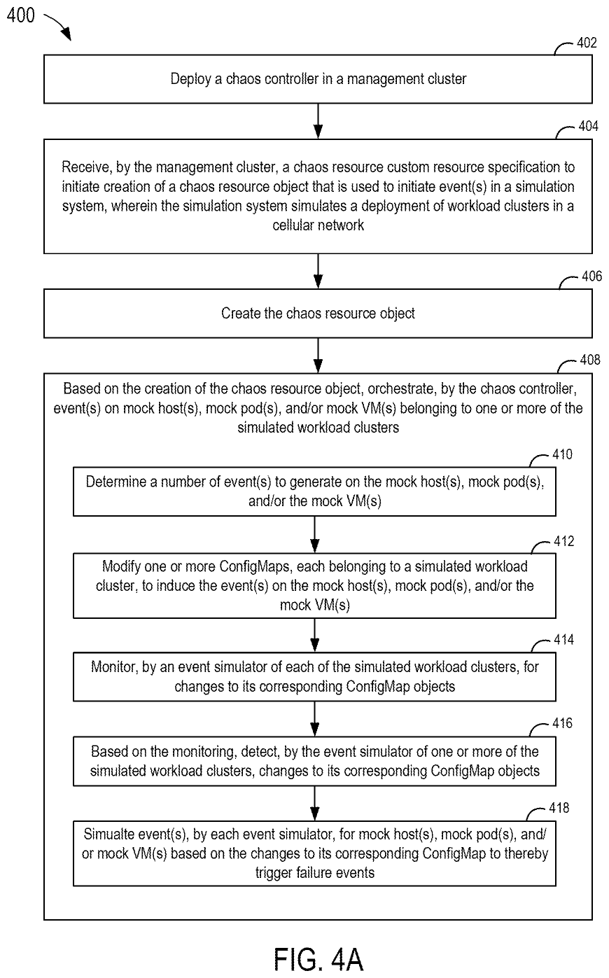

In certain embodiments, management cluster 318 includes a chaos controller 332. Chaos controller 332 is configured to orchestrate the injection of various types of events in one or more of the workload clusters 336 (e.g., in the test environment) managed by management cluster 318. For example, chaos controller 332 is configured to monitor for chaos resource objects 326 created in cluster store (etcd) 322. Chaos resource objects 326 are custom resources that declare a number, type, and/or frequency of events intended for one or more of workload cluster(s) 336. A chaos resource object 326 may be created in cluster store (etcd) 322 in response to management cluster 318 receiving a CRD (e.g., created by a user) and custom resource specification used to provision the chaos resource object 326. The CRD and/or custom resource specification may include information about the number, type, and/or frequency of events intended for one or more of the managed workload clusters 336. Example chaos resource specifications are provided and described in detail below with respect to FIGS. 5-8.

When a chaos resource object 326 is detected by chaos controller 332 (e.g., based on the monitoring), chaos controller 332 uses best efforts to strategically orchestrate the specified events to one or more workload clusters 336 and/or components of the workload cluster(s) 336. In other words, chaos controller 332 works to modify a state of one or more workload clusters 336 to match an intended state of the workload clusters specified in, at least, the detected chaos resource object 326.

Each workload cluster 336 may include an event simulator 348 running on a worker node within the corresponding workload cluster 336. Events orchestrated and intended, by chaos controller 332, to be induced in a particular workload cluster 336 may be simulated by an event simulator 348 deployed in the particular workload cluster 336. In particular, chaos controller 332 may communicate with each event simulator 348, of each workload cluster 336, events that are to be triggered in its corresponding workload cluster 336 by the event simulator 348. Simulation of these event(s), by event simulator(s) 348 may lead to failures and thus trigger failure events that propagate as alerts to the TCP of SDDC 101. Events received by the TCP may be analyzed to observe how different events affect operations of workload clusters 336 and their resources (e.g., hosts, VMs, etc.), as well as application (e.g., CNF) performance. Further, the events, when analyzed, may provide information about issues and/or performance bottlenecks among workload clusters 336. As such, the deployment of chaos controller 332 in management cluster 318 allows for centralized, efficient, and cost-effective event simulation and injection in one or more workload clusters 336 to provide a better understanding of performance of the RAN deployment (e.g., without actually modifying the RAN deployment).

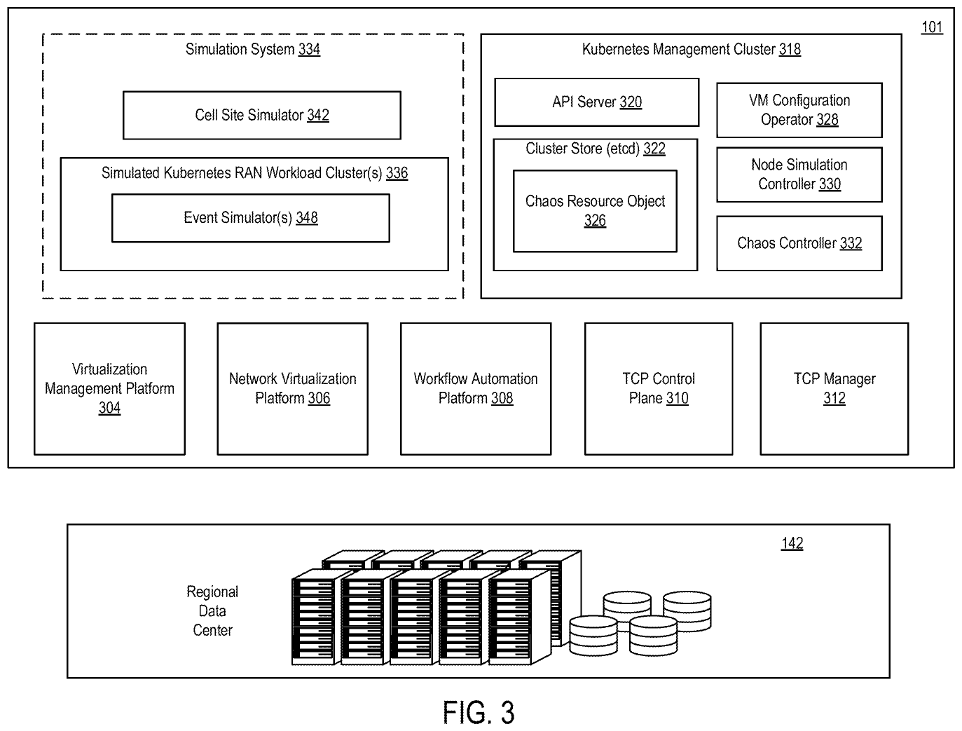

FIG. 4A illustrates example operations 400 for introducing event(s) in one or more simulated container-based clusters. In certain aspects, the one or more simulated container-based clusters are simulated Kubernetes RAN workload clusters (e.g., such as workload clusters 336 illustrated in FIG. 3), and the event(s) injected in these clusters are used to help understand how the simulated RAN deployment (e.g., representing a real-world RAN production environment) reacts to various load, stressors, failures/faults, churn, and/or the like.

FIG. 4B illustrates an example system used to simulate event(s) in simulated container-based clusters. Example event simulation illustrated in FIG. 4B may be performed based on example operations 400 depicted in FIG. 4A. As such, FIGS. 4A and 4B are described in conjunction below.

Operations 400 begin, at operation 402, with deploying a chaos controller in a management cluster. The management cluster may be configured to run cluster API operations to manage one or more workload clusters where event(s) are to be injected.

For example, in FIG. 4B, two workload clusters 336(1) and 336(2) are simulated in simulation system 334. Workload cluster 336(1) includes mock VMs 424(1)-(3) running on mock hosts 422(1)-(3). Workload cluster 336(2) includes mock VMs 424(4)-(6) running on mock hosts 422(4)-(6). Mock VMs 424(1)-(6) and mock hosts 422(1)-(6) in simulation system 334 represent cell site VMs and hosts, respectively, in a cellular network (e.g., such as cellular network 100 illustrated in FIG. 1). Although not shown, CNFs may be deployed as pods of containers running within mock VMs 424(1)-(6) of the cell site, mock hosts 422(1)-(6).

Management cluster 318 may be configured to create and manage workload clusters 336(1)-(2) in simulation system 334. A chaos controller 332 may be deployed in management cluster 318 (e.g., according to operation 402 in FIG. 4) to orchestrate and trigger the simulation of event(s) in workload cluster 336(1) only, in workload cluster 336(2) only, or in both workload cluster 336(1) and workload cluster 336(2).

Operations 400 proceed, at operation 404, with the management cluster receiving a chaos resource specification (e.g., and a chaos resource CRD). The chaos resource specification may be used to initiate the creation of a chaos resource object that is further used to initiate event(s) in a simulation system (e.g., where the simulation system simulates a deployment of workload clusters in a cellular network). At operation 406, based on receiving the chaos resource specification, a chaos resource object is created in a cluster store (etcd) of the management cluster.

The chaos resource specification, and accordingly the chaos resource object created from the chaos resource specification, may declare a number, type and/or frequency of events that are to be simulated for simulated workload cluster(s) managed by the management cluster. Further, the chaos resource object may declare one or more targets of the simulated event(s). In certain embodiments, the targets of the simulated event(s) are workload cluster(s) managed by the management cluster and explicitly identified in the chaos resource specification. In certain embodiments, instead of specifying a particular workload cluster, a creator of the chaos resource specification simply indicates that “multiple” workload clusters managed by the management cluster are targets of the simulated events. Thus, the “multiple” workload clusters for which this chaos resource specification applies may be decided by the chaos controller, as described in detail below.

In certain embodiments, the chaos resource specification declares that a “burst” type event is to occur. Burst type events declared by the chaos resource specification may indicate that multiple node failure instances for nodes in one or more of the simulated workload clusters are to be triggered in the simulation system. A first node failure instance may generate events used to cause a first percentage (e.g., 25%) of nodes in one or more of the simulated workload clusters to fail. A second node failure instance may generate events used to cause a second percentage (e.g., 50%) of nodes in one or more of the simulated workload clusters to fail, where the second percentage is greater than the first percentage. Additional node failure instances may be triggered until 100% of the nodes in one or more of the simulated workload clusters fail due to events generated for one of the node failure instances (e.g., a third node failure instance may trigger a 75% failure and a fourth node failure instance may trigger a 100% failure). In addition to declaring a burst event, the chaos resource specification may additionally indicate the wait time between node failure instances, or in other words, a frequency of performing the node failures triggered by the burst type event. Further, the chaos resource specification may indicate the particular workload cluster(s) where events are to be generated to carry out the node failure instances for the burst type event.

FIG. 5 illustrates an example chaos resource specification 500 (e.g., shown as “kind: ChaosResource” at 502) declaring that a burst type event is to occur. In particular, at 504 and 506, respectively, example chaos resource specification 500 indicates that the event type is a “BURST” type event, and node failure instances for the burst type event are to occur every two minutes (e.g., “waitTime: 2m”). At 508 and 510, respectively, example chaos resource specification 500 indicates that the burst is to occur across multiple workload clusters (e.g., clusterOption: MULTIPLE) and, more specifically, is targeted for “ALL” simulated workload clusters managed by a management cluster that receives chaos resource specification 500. Example chaos resource specification 500 also provides, at 510, specifics for creating the node failures for each of the burst node failure instances. In this example, a kubelet of each of the failed nodes may be configured to be “unready” (e.g., “kubeletUnready: true”).

In certain other embodiments, the chaos resource specification declares that one or more “flip” type events are to occur. Flip type events declared by the chaos resource specification may indicate that one or multiple flips are to occur for nodes in the simulation system. Each flip results in events being generated to cause one or more nodes in one or more simulated workload clusters to transition to a failure state (e.g., fail) and then return to a non-failure state (e.g., after a wait time has passed, where the wait time is defined for the flip in the chaos resource specification). In addition to declaring one or more flip type events and specifying wait time(s) for the flip(s), the chaos resource specification may also indicate the particular workload cluster(s) where events are to be generated to carry out multiple flips. Further, the chaos resource specification may declare, in some cases, for the particular workload cluster(s), a percentage of nodes (e.g., 30%) belonging to these workload cluster(s) that are to be flipped. In cases where a percentage is not provided, a default percentage of nodes (e.g., 25%) belonging to these workload cluster(s) may be flipped.

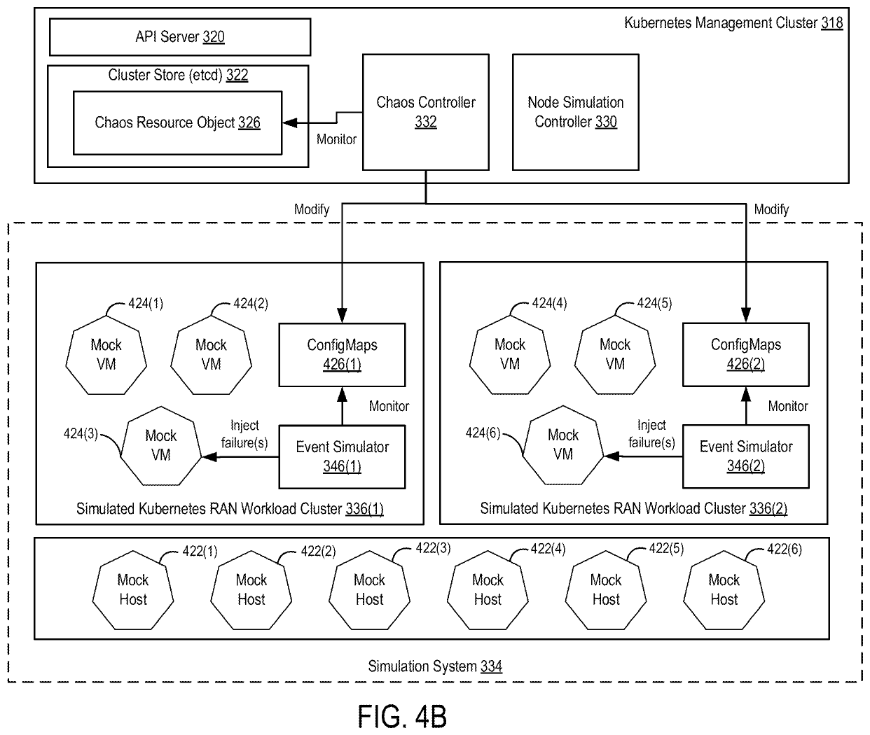

FIG. 6 illustrates an example chaos resource specification 600 (e.g., shown as “kind: ChaosResource” at 602) declaring that a flip type event (e.g., one flip event) is to occur. In particular, at 604 and 606, respectively, example chaos resource specification 600 indicates that the event type is a “FLIP” type event, and an amount of time to wait between transitioning to a failure state and then back to a non-failure state that is equal to two minutes (e.g., “waitTime: 2m”). At 608 and 610, respectively, example chaos resource specification 600 indicates that the flips are to occur across multiple workload clusters (e.g., clusterOption: MULTIPLE) and, more specifically, are targeted for “ALL” simulated workload clusters managed by a management cluster that receives chaos resource specification 500. Example chaos resource specification 600 also provides, at 610, specifics for creating the node failures for each of the flips. In this example, a kubelet of each of the failed nodes in a flip may be configured to be “unready” (e.g., “kubeletUnready: true”).

In certain other embodiments, the chaos resource specification declares that an “all” type event is to occur. All type events declared by the chaos resource specification may indicate that that multiple node failure instances for nodes in one or more of the simulated workload clusters are to be triggered in the simulation system. Each node failure instance may generate events used to cause all nodes (e.g., 100% of the nodes) in one or more of the simulated workload clusters to fail. In addition to declaring an all type event, the chaos resource specification may additionally indicate the wait time between node failure instances, or in other words, a frequency of performing the node failures triggered by the all type event. Further, the chaos resource specification may indicate the particular workload cluster(s) where events are to be generated to carry out the node failure instances for the all type event.

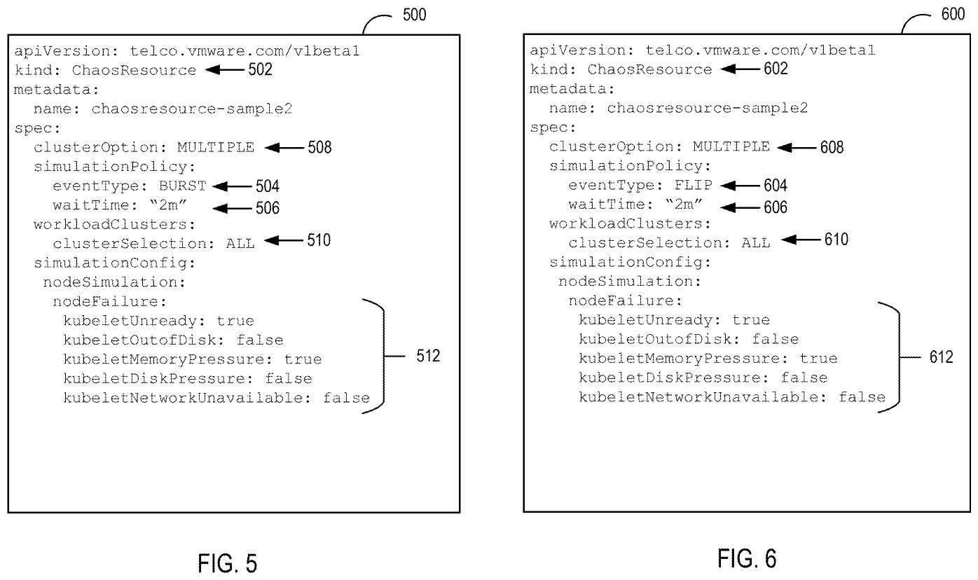

FIG. 7 illustrates an example chaos resource specification 700 (e.g., shown as “kind: ChaosResource” at 702) declaring that an all type event is to occur. In particular, at 704 and 706, respectively, example chaos resource specification 700 indicates that the event type is an “ALL” type event, and node failure instances for the all type event are to occur every five minutes (e.g., “waitTime: 5m”). At 708, example chaos resource specification 700 indicates that the all type event is targeted for a single workload cluster named “workload-scale-01” (e.g., as opposed to targeting “ALL” simulated workload clusters managed by a management cluster that receives chaos resource specification 700, previously illustrated in chaos resource specifications 500 and 600). Example chaos resource specification 700 also provides, at 710 and 712, respectively, specifics for creating the node failures and the pod failures for workload cluster “workload-scale-01.”

In certain other embodiments, the chaos resource specification declares that a “partial” type event is to occur. Partial type events declared by the chaos resource specification may indicate that that multiple node failure instances for nodes in one or more of the simulated workload clusters are to be triggered in the simulation system. Each node failure instance may generate events used to cause a specified percentage of nodes (e.g., less than 100% of the nodes, such as 50%) in one or more of the simulated workload clusters to fail. In addition to declaring a partial type event, the chaos resource specification may additionally indicate the wait time between node failure instances, or in other words, a frequency of performing the node failures triggered by the partial type event. Further, the chaos resource specification may indicate the particular workload cluster(s) where events are to be generated to carry out the node failure instances for the partial type event.

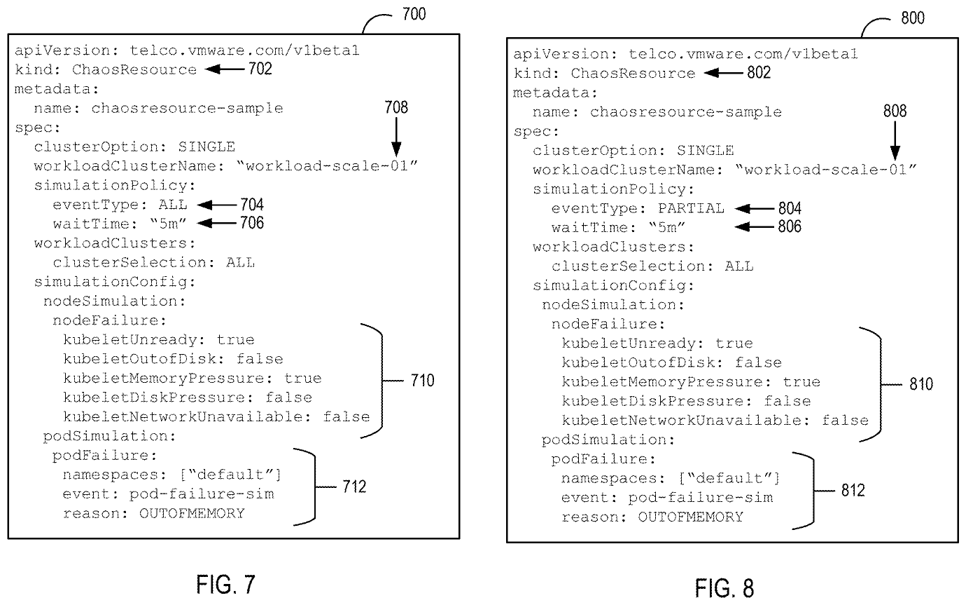

FIG. 8 illustrates an example chaos resource specification 800 (e.g., shown as “kind: ChaosResource” at 802) declaring that a partial type event is to occur. In particular, at 804 and 806, respectively, example chaos resource specification 800 indicates that the event type is a “PARTIAL” type event, and node failure instances for the partial type event are to occur every five minutes (e.g., “waitTime: 5m”). For example chaos resource specification 800, instead of requiring the creator of chaos resource specification 800 to specify a percentage, the creator may just indicate “PARTIAL.” (e.g., which is associated with a pre-configured percentage). At 808, example chaos resource specification 800 indicates that the all type event is targeted for a single workload cluster named “workload-scale-01”. Example chaos resource specification 800 also provides, at 810 and 812, respectively, specifics for creating the node failures and the pod failures for workload cluster “workload-scale-01.”

Obtaining information about various workload clusters (e.g., such as workload cluster name) may be an easier task, for a creator of a chaos resource specification, than obtaining information about nodes deployed across the workload clusters. As such, the above-described example chaos resource specifications enable a user to specify one or multiple workload clusters that are targets for simulated events. However, this does not preclude the ability of a creator of a specification from specifying a particular node (or multiple nodes) as a target for one or more simulated events. In particular, in certain other embodiments, chaos resource specifications may enable a creator to specify the name of a particular, targeted node in the simulation system.

It is noted that the above-described chaos resource specifications are only example specifications that may be received by the management cluster (and further used to create chaos resource objects). In other words, the above-described chaos resource specifications are not an exhaustive list, and many other chaos resource specifications may be provided to the management cluster.

To carry out operation 404 in the example illustrated in FIG. 4B, management cluster 318 receives a chaos resource specification (not shown). At operation 406, based on receiving the chaos resource specification, a chaos resource object 326 is created in cluster store (etcd) 322. Although not meant to be limiting to this specific example, it may be assumed that the chaos resource specification received by management cluster 318 is example chaos resource specification 500 illustrated in FIG. 5. As such, chaos resource object 326, created from chaos resource specification 500, may declare that a burst type event is to occur. The burst type event may include three node failure instances, each occurring two minutes apart. The first node failure instance may trigger events used to cause 33% of the nodes (in this example, mock VMs 424) across workload clusters 336(1) and 336(2) to fail, the second node failure instance may trigger events used to cause 66% of the nodes across workload clusters 336(1) and 336(2) to fail, and the third node failure instance may trigger events used to cause 100% of the nodes across workload clusters 336(1) and 336(2) to fail.

Operations 400 then proceed, at operation 408, with the chaos controller orchestrating event(s) on mock host(s), mock pod(s), and/or mock VM(s) belonging to one or more of the simulated workload clusters. The chaos controller is configured to perform this orchestration based on monitoring for the creation of a chaos resource object in the cluster store (etcd). Based on the monitoring, the chaos controller may detect the creation of the chaos resource object. The chaos resource object is a “record of intent;” thus, once the chaos resource object is created, the chaos controller will constantly work to ensure that the intended state represented by the object, i.e., the desired event(s), are realized in the system. In other words, the chaos controller works to inject one or more events in one or more workload clusters according to specifics associated with the chaos resource object.

The orchestration of event(s) by chaos controller, at operation 408, may include operations 410-418. In particular, at operation 410, the chaos controller determines a number of event(s) to generate on the mock host(s), mock pod(s), and/or the mock VM(s).

For example, in FIG. 4B, based on chaos controller 332 detecting the creation of chaos resource object 326 (e.g., which, for this example, is example chaos resource specification 500 illustrated in FIG. 5), chaos controller 332 determines that three node failure instances are to occur. More specifically, chaos controller 332 determines that (1) a first amount of events are to be generated in the first node failure instance to cause 33% of mock VMs 424 across workload clusters 336(1) and 336(2) to fail, (2) a second amount of events are to be generated in the second node failure instance to cause 66% of mock VMs 424 across workload clusters 336(1) and 336(2) to fail, and (3) a third amount of events are to be generated in the third node failure instance to cause 100% of mock VMs 424 across workload clusters 336(1) and 336(2) to fail.

In addition to determining the number of events needed for each node failure instance, chaos controller 332 may determine how to apply these events across workload clusters 336(1) and 336(1).

For example, in a first implementation, chaos controller 332 may determine that 33% of the mock VM 424 failures in the first node failure instance may be induced by generating events on both workload cluster 336(1) and 336(2) to each cause a single mock VM 424, belonging to each of the workload clusters 336(1)-(2), to fail. Further, chaos controller 332 may determine that 66% of the mock VM 424 failures in the second node failure instance may be caused by generating events on both workload cluster 336(1) and 336(2) to each cause two mock VMs 424, belonging to each of the workload clusters 336(1)-(2), to fail. Lastly, chaos controller 332 may determine that 100% of the mock VM 424 failures in the third node failure instance may be caused by generating events on both workload cluster 336(1) and 336(2) to each cause three mock VMs 424, belonging to each of the workload clusters 336(1)-(2), to fail. As such, chaos controller 332 may determine that events are to be triggered at each workload cluster 336(1)-(2) to carry out each node failure instance initiated by the burst type event.

Alternatively, in a second implementation, chaos controller 332 may determine that 33% of the mock VM 424 failures in the first node failure instance may be induced by generating events only workload cluster 336(1) such that two mock VMs 424, belonging to only workload cluster 336(1), fail. Further, chaos controller 332 may determine that 66% of the mock VM 424 failures in the second node failure instance may be caused by generating events on both workload cluster 336(1) and 336(2) such that three mock VMs 424 belonging to workload cluster 336(1) fail and one mock VM 424 belonging to workload cluster 336(2) fails (e.g., a total of four mock VM 424 failures). Lastly, chaos controller 332 may determine that 100% of the mock VM 424 failures in the third node failure instance may be caused by generating events on both workload cluster 336(1) and 336(2) to each cause three mock VMs 424, belonging to each of the workload clusters 336(1)-(2), to fail. As such, chaos controller 332 may determine that events are to be triggered on only workload cluster 336(1) for the first node failure instance, while events are to be triggered on both workload cluster 336(1) and 336(2) for the second and third node failure instances.

It is noted that the above-described implementations are only examples, and chaos controller 332 may make other determinations of how to orchestrate events across workload clusters 336 when detecting chaos resource object 326, especially in cases where (1) the event type specified in the chaos resource object 326 is different than the example provided in FIG. 4B and/or (2) where the number of workload clusters 336, mock hosts 422, mock pods (not shown), and/or mock pods are different than the number of components illustrated in the example in FIG. 4B.

At operation 412, the chaos controller modifies one or more ConfigMaps, each belonging to a simulated workload cluster, to induce the event(s) on the mock host(s), mock pod(s), and/or the mock VM(s). The chaos controller determines which ConfigMap(s) to modify, and how to modify them, based on the determination made at operation 408.

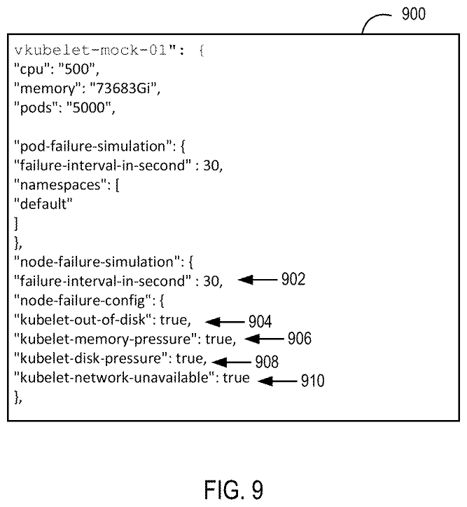

ConfigMaps are API objects used to store configuration data separate from application code. In particular, ConfigMaps allow for the decoupling of environment-specific configurations from containers in a workload cluster. ConfigMaps hold key-value pairs of configuration data (e.g., described in more detail below with respect to FIG. 9) that can be consumed in pods and/or used to store configuration data for system components such as controllers. For example, a specification of a pod object may refer to a ConfigMap and configure container(s) in that pod based on the data in the ConfigMap.

Modification of ConfigMaps by the chaos controller, at operation 412, may update one or more key-value pairs stored in the ConfigMaps to indicate a change in configuration data. For example, assuming the first implementation described above is determined by chaos controller 332 in FIG. 4B, chaos controller 332 initiates the first node failure instance (e.g., for the burst type event) by modifying ConfigMaps 426(1) deployed in workload cluster 336(1) and ConfigMaps 426(2) deployed in workload cluster 336(2). Chaos controller 332 modifies key-values pairs of ConfigMaps 426(1) to trigger the failure of one mock VM 424 in workload cluster 336(1). Further, chaos controller 332 modifies key-value pairs of ConfigMaps 426(2) to trigger the failure of one mock VM 424 in workload cluster 336(2).

Example key-value pairs that may be modified in a ConfigMap 900 to initiate a node failure are illustrated in FIG. 9. Each key-value pair 902-910 in ConfigMap 900, for the node failure, includes (1) a key that specifies a particular configuration for the node failure and (2) a value defined for that corresponding configuration. For example, key-value pair 902 includes a key “failure-interval-in-second” and a value “30.” Value “30” may be a value manipulated by chaos controller 332 when chaos controller 332 decides to initiate a node failure, such that the node failure interval for the node failure is configured to occur in 30 second intervals. Key-value pairs 902-910 illustrated in FIG. 9 are only some example key-value pairs that may be updated for a node failure, and other key-value pairs not shown in FIG. 9 may also be updated for a node failure. Further, additional key-value pairs in ConfigMaps may also be updated for other failures/events that are to be triggered in the container-based system.

At operations 414 and 416, an event simulator, of each of the simulated workload clusters, monitors for changes to its corresponding ConfigMaps, and based on the monitoring, detect one or more changes. Each event simulator that detects changes to its corresponding ConfigMaps, then works to simulate event(s) for a workload cluster where the event simulator is deployed. In particular, at operation 418, each event simulator simulates one or more events for mock host(s), mock pod(s), and/or mock VM(s) associated with the workload cluster where the event simulator is deployed and based on the detected changes in the event simulator's corresponding ConfigMaps. Events simulated by each event simulator may trigger additional events, such as failure events, that propagate as alerts to a TCP of an SDDC where the management cluster is deployed.

For example, in FIG. 4B, based on monitoring ConfigMaps 426(1), event simulator 346(1), deployed in workload cluster 336(1), detects change(s) to ConfigMaps 426(1). As described above, the change(s) to ConfigMaps 426(1) may trigger event simulator 346(1) to simulate and inject events to cause one mock VM, e.g., mock VM 424(3) in workload cluster 336(1), to fail. Similarly, based on monitoring ConfigMaps 426(2), event simulator 346(2), deployed in workload cluster 336(2), detects change(s) to ConfigMaps 426(2). As described above, the change(s) to ConfigMaps 426(12) may trigger event simulator 346(2) to simulate and inject events to cause one mock VM, e.g., mock VM 424(6) in workload cluster 336(2), to fail. Failure of mock VM 424(3) and mock VM 424(6) may trigger failure vents that propagate as alerts to a TCP (e.g., such as the TCP in FIG. 3 illustrated as TCP control plane 310 and TCP manager 312) of an SDDC where management cluster 318 is running.

Because chaos resource object 326 indicates a burst type event is intended, chaos controller 332, event simulator 346(1), and event simulator 346(2) may perform operations 410-418 three times. Specifically, operations 410-418 may be performed for a second time to carry out the second node failure instance (e.g., to cause 66% of mock VMs 424 to fail), and operations 410-418 may be performed for a third time to carry out the third node failure instance (e.g., to cause 100% of mock VMs 424 to fail).

Failure events generated by each of these node failure instances and reported to the TCP may be analyzed to better understand how workload clusters 336(1)-(2), components in workload clusters 336(1)-(2), and/or application performance (e.g., of applications deployed in workload cluster 336(1)-(2)) is affected by various load, stressors, failures/faults, churn, and/or the like introduced in workload clusters 336(1)-(2).

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) —CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for orchestrating simulated events in a distributed container-based system, comprising:
monitoring, by a chaos controller deployed in a management cluster of the container-based system, for objects generated at the management cluster, wherein the management cluster is configured to manage a plurality of simulated workload clusters in a simulation system;
based on the monitoring, discovering, by the chaos controller, a chaos resource object generated at the management cluster providing information about events intended to be simulated for one or more simulated workload clusters of the plurality of simulated workload clusters;
determining a plan for orchestrating a simulation of the events in the one or more simulated workload clusters based on the information provided in the chaos resource object; and
triggering the simulation of the events in accordance with the plan.

2. The method of claim 1, wherein the information about the events intended to be simulated for the one or more simulated workload clusters comprises at least one of:
a type of the events intended to be simulated,
a timing for simulating the events, or
an indication of the one or more workload clusters from the plurality of simulated workload clusters where the events are intended to be simulated.

3. The method of claim 2, wherein the type of the events intended to be simulated comprises one or more of:
a burst type triggering simulation of events used to cause different percentages of nodes in the one or more simulated workload clusters to fail over a first period of time,
a flip type triggering simulation of events used to cause different sets of nodes in the one or more simulated workload clusters to transition to a failure state and then return to a non-failure state over a second period of time,
an all type triggering simulation of events used to cause all nodes in the one or more simulated workload clusters to fail during multiple instances over a third period of time, or a partial type triggering simulation of events used to cause a percentage of nodes in the one or more simulated workload clusters to fail during multiple instances over a fourth period of time.

4. The method of claim 3, wherein:
the type of the events intended to be triggered comprises the flip type, and
an amount of nodes in each of the different sets of nodes is equal.

5. The method of claim 3, wherein the nodes in the one or more simulated workload clusters comprise virtual machines or host machines simulated in the simulation system.

6. The method of claim 2, wherein the indication of the one or more workload clusters comprises:
an indication of all simulated workload clusters in the plurality of simulated workload clusters, or
a name of a simulated workload cluster in the plurality of simulated workload clusters.

7. The method of claim 1, wherein triggering the simulation of the events in accordance with the plan comprises modifying one or more configuration maps belonging to the one or more simulated workload clusters to initiate the simulation of the events by an event simulator deployed in each of the one or more simulated workload clusters.

8. The method of claim 1, wherein the chaos resource object is generated at the management cluster based on the management cluster receiving a chaos resource custom resource specification.

9. The method of claim 1, wherein the events comprise at least one of:
outages,
failures,
excess churn, or
changes in resources that disrupt the container-based system.

10. A system comprising:
one or more processors; and
at least one memory, the one or more processors and the at least one memory configured to:
monitor, by a chaos controller deployed in a management cluster of a container-based system, for objects generated at the management cluster, wherein the management cluster is configured to manage a plurality of simulated workload clusters in a simulation system;
based on the monitoring, discover, by the chaos controller, a chaos resource object generated at the management cluster providing information about events intended to be simulated for one or more simulated workload clusters of the plurality of simulated workload clusters;
determine a plan for orchestrating a simulation of the events in the one or more simulated workload clusters based on the information provided in the chaos resource object; and
trigger the simulation of the events in accordance with the plan.

11. The system of claim 10, wherein the information about the events intended to be simulated for the one or more simulated workload clusters comprises at least one of:
a type of the events intended to be simulated,
a timing for simulating the events, or
an indication of the one or more workload clusters from the plurality of simulated workload clusters where the events are intended to be simulated.

12. The system of claim 11, wherein the type of the events intended to be simulated comprises one or more of:
a burst type triggering simulation of events used to cause different percentages of nodes in the one or more simulated workload clusters to fail over a first period of time,
a flip type triggering simulation of events used to cause different sets of nodes in the one or more simulated workload clusters to transition to a failure state and then return to a non-failure state over a second period of time,
an all type triggering simulation of events used to cause all nodes in the one or more simulated workload clusters to fail during multiple instances over a third period of time, or
a partial type triggering simulation of events used to cause a percentage of nodes in the one or more simulated workload clusters to fail during multiple instances over a fourth period of time.

13. The system of claim 12, wherein:
the type of the events intended to be triggered comprises the flip type, and
an amount of nodes in each of the different sets of nodes is equal.

14. The system of claim 12, wherein the nodes in the one or more simulated workload clusters comprise virtual machines or host machines simulated in the simulation system.

15. The system of claim 11, wherein the indication of the one or more workload clusters comprises:
an indication of all simulated workload clusters in the plurality of simulated workload clusters, or
a name of a simulated workload cluster in the plurality of simulated workload clusters.

16. The system of claim 10, wherein to trigger the simulation of the events in accordance with the plan comprises to modify one or more configuration maps belonging to the one or more simulated workload clusters to initiate the simulation of the events by an event simulator deployed in each of the one or more simulated workload clusters.

17. The system of claim 10, wherein the chaos resource object is generated at the management cluster based on the management cluster receiving a chaos resource custom resource specification.

18. The system of claim 10, wherein the events comprise at least one of:
outages,
failures,
excess churn, or
changes in resources that disrupt the container-based system.

19. A non-transitory computer-readable medium comprising instructions that, when executed by one or more processors of a computing system, cause the computing system to perform operations for orchestrating simulated events in a distributed container-based system, the operations comprising:
monitoring, by a chaos controller deployed in a management cluster of the container-based system, for objects generated at the management cluster, wherein the management cluster is configured to manage a plurality of simulated workload clusters in a simulation system;
based on the monitoring, discovering, by the chaos controller, a chaos resource object generated at the management cluster providing information about events intended to be simulated for one or more simulated workload clusters of the plurality of simulated workload clusters;
determining a plan for orchestrating a simulation of the events in the one or more simulated workload clusters based on the information provided in the chaos resource object; and
triggering the simulation of the events in accordance with the plan.

20. The non-transitory computer-readable medium of claim 19, wherein the information about the events intended to be simulated for the one or more simulated workload clusters comprises at least one of:
a type of the events intended to be simulated,
a timing for simulating the events, or
an indication of the one or more workload clusters from the plurality of simulated workload clusters where the events are intended to be simulated.
